(19) United States
(12) Patent Application Publication
(10) Pub. No.: US 2013/0159346 A1
(43) Pub. Date: Jun. 20, 2013

(54) COMBINATORIAL DOCUMENT MATCHING

(71) Applicants: Kas Kasravi, W. Bloomfield, MI (US); Mehmet Kivanc Ozonat, San Jose, CA (US); Claudio Bartolini, Palo Alto, CA (US)

(72) Inventors: Kas Kasravi, W. Bloomfield, MI (US); Mehmet Kivanc Ozonat, San Jose, CA (US); Claudio Bartolini, Palo Alto, CA (US)

(21) Appl. No.: 13/327,505

(22) Filed: Dec. 15, 2011

(51) Int. Cl. G06F 17/30

(52) U.S. Cl. 707/771; 707/758; 707/E17.014; 707/E17.008

(57) ABSTRACT

Embodiments of the present invention disclose a method and system for combinatorial document matching. According to one embodiment, a target document and a plurality of source documents are received by the system. Thereafter, consolidated source document information associated with the plurality of source documents and permutated concept data affiliated with the target document are created. Based on comparisons of the permutated concept data and the consolidated source document information, a set of relevant documents from the plurality of source documents are determined.

### BACKGROUND

Due to the copious amounts of information attributable to the popularity of personal computing and the internet, it has become increasingly difficult for users to effectively sift through and examine such an extensive data or document set. In addition, document search, and particularly document matching, has been the subject of numerous research and commercial tools. Document matching is generally utilized for searching and clustering similar documents, organizing folders, and other content management purposes.

Typically, a document of interest is identified, and similar documents are matched against the target document on a one-to-one basis given their semantic similarity. In cases where the key concepts in a target document are present in combination within multiple documents, the user faces the tedious process of breaking down the concepts in the document of interest, performing partial matches, determining the relevance of the documents, and manually compiling a set of documents, which in combination, match the document of interest.

### BRIEF DESCRIPTION OF THE DRAWINGS

The features and advantages of the inventions as well as additional features and advantages thereof will be more clearly understood hereinafter as a result of a detailed description of particular embodiments of the invention when taken in conjunction with the following drawings in which:

FIG. 1 is a simplified block diagram of a combinatorial document matching system according to an example of the present invention.

FIG. 2 is a more detailed block diagram of the combinatorial document matching system according to an example of the present invention.

FIG. 3A is a simplified flow chart of the processing steps of a method for performing combinatorial document matching in accordance with an example of the present invention.

FIG. 3B is a simplified flow chart of the processing steps for constructing consolidated document source information in accordance with an example of the present invention.

FIG. 3C is a simplified flow chart of the processing steps for creating a permutated data set associated with the target document according to an example of the present invention.

FIG. 3D is a simplified flow chart of the processing steps for determining a set of relevant documents in accordance with an example of the present invention.

### DETAILED DESCRIPTION OF THE INVENTION

The following discussion is directed to various embodiments. Although one or more of these embodiments may be discussed in detail, the embodiments disclosed should not be interpreted, or otherwise used, as limiting the scope of the disclosure, including the claims. In addition, one skilled in the art will understand that the following description has broad application, and the discussion of any embodiment is meant only to be an example of that embodiment, and not intended to intimate that the scope of the disclosure, including the claims, is limited to that embodiment. Furthermore, as used herein, the designators “A”, “B” and “N” particularly with respect to the reference numerals in the drawings, indicate that a number of the particular feature so designated can be included with examples of the present disclosure. The designators can represent the same or different numbers of the particular features.

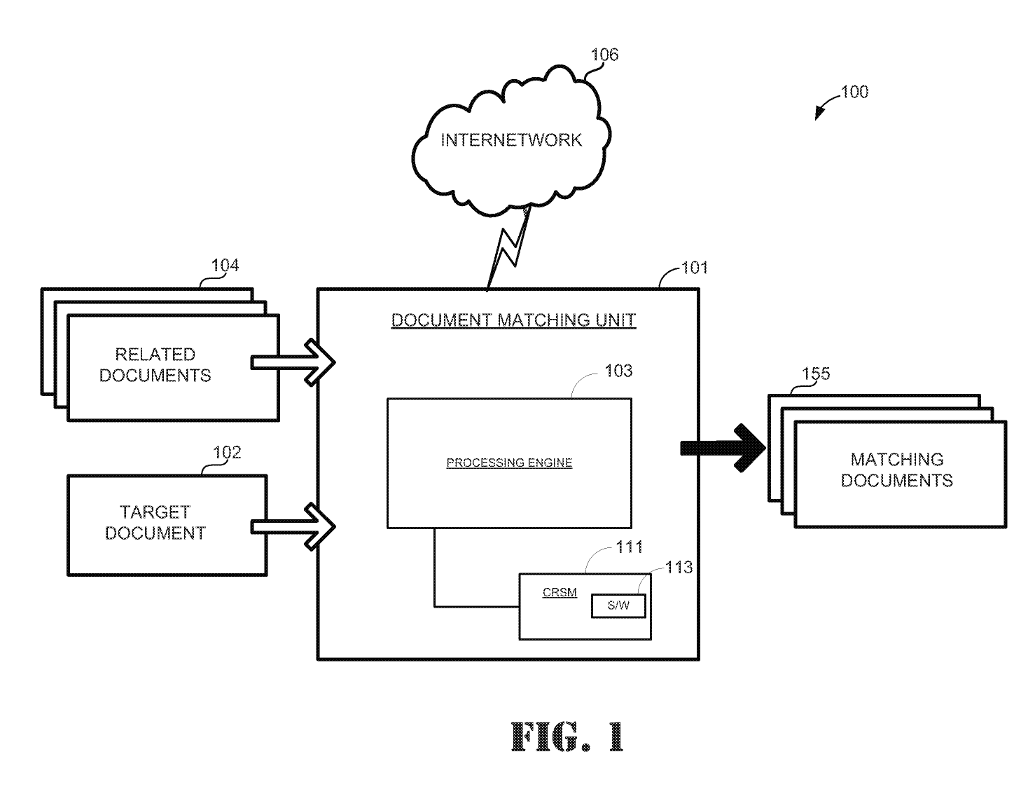

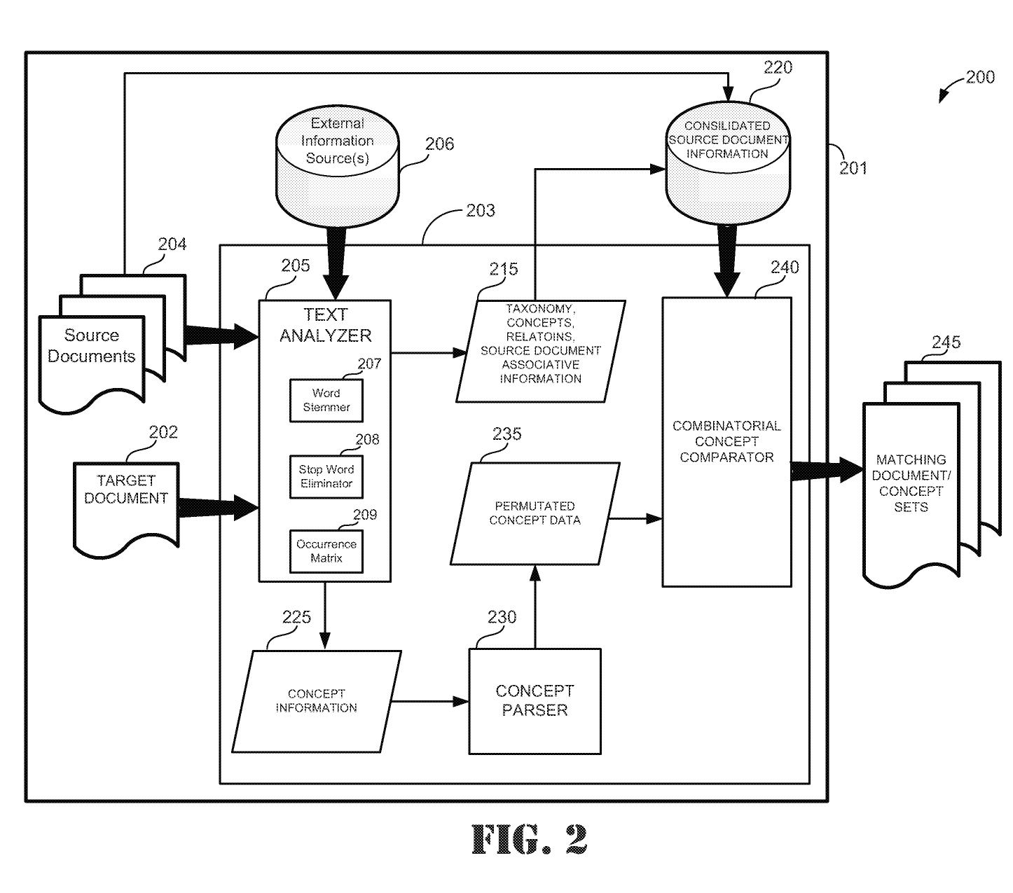

The figures herein follow a numbering convention in which the first digit or digits correspond to the drawing figure number and the remaining digits identify an element or component in the drawing. Similar elements or components between different figures may be identified by the user of similar digits. For example, 143 may reference element “43” in FIG. 1, and a similar element may be referenced as 243 in FIG. 2. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

Unless specifically stated otherwise as apparent from the following discussions, it is appreciated that throughout the description of embodiments, discussions utilizing terms such as “detecting,” “determining,” “operating,” “using,” “accessing,” “comparing,” “associating,” “deleting,” “adding,” “updating,” “receiving,” “transmitting,” “inputting,” “outputting,” “creating,” “obtaining,” “executing,” “storing,” “generating,” “annotating,” “extracting,” “causing,” “transforming data,” “modifying data to transform the state of a computer system,” or the like, refer to the actions and processes of a computer system, data storage system, storage system controller, microcontroller, processor, or similar electronic computing device or combination of such electronic computing devices. The computer system or similar electronic computing device manipulates and transforms data represented as physical (electronic) quantities within the computer system's/device's registers and memories into other data similarly represented as physical quantities within the computer system's/device's memories or registers or other such information storage, transmission, or display devices.

Prior solutions for document matching involve comparing a target document with a semantically identical document. Historically, document matching techniques have focused on matching pairs of documents based on their similarities (i.e., identity). For example, automated document matching is the process of determining if two or more documents are semantically similar. Automated document matching relies on computational linguistics and text analysis capabilities, which consider synonyms, thesauri, lexicology, anaphora resolution, as well as statistical methods. In many cases, however, all the key concepts in a target document may not be present on a one-to-one basis in other documents. In such cases, either the document matching process fails, or the similarity threshold has to be reduced. The latter scenario may lead to numerous unwanted false-positive matches. For example, if a target document has key elements ABMNXY, while a first relevant document has elements AB, a second relevant document contains elements MN, and a third relevant document includes elements XY; then, it is apparent that no individual document exactly matches the target document. However, the first, second, and third relevant documents—in combination—match the target document. Many applications, such as searches for sales collateral, patent obviousness, plagiarism detection, and other advanced document search techniques can benefit from matching documents in combinations. Therefore, there is a need to match multiple documents against a target document, where the key concepts of the target document appear, collectively, in a combination of two or more other relevant documents.

Embodiments of the present invention disclose a method and system for combinatorial document matching. More particularly, examples disclosed herein provide a method for identifying a collection of documents, which in combination match a target document. According to one example embodiment, via text or linguistic analysis, key concepts in a target document are identified and analyzed. A similar process analyzes a source document library, and combinations of information associated with the plurality of the documents are used to match information affiliated with the target document. If a match is determined, the set of documents are returned as relevant documents, which in combination, match or substantially correspond to the target document. Hence, document search capabilities can be significantly enhanced by avoiding false negatives resulting from each document possessing only portions of the target document and not a full match onto itself. The advantages afforded by examples or the present invention include better search results for sales collateral, more effective plagiarism and patent obviousness detection, legal precedent identification, and improved eDiscovery for example.

Referring now in more detail to the drawings in which like numerals identify corresponding parts throughout the views, FIG. 1 is a simplified block diagram of a combinatorial document matching system according to an example of the present invention. As shown here, the combinatorial document matching system 100 includes a target document 104 and set of source documents 102 for matching analysis by the document analyzing unit 101. As will be described in further detail with reference to FIG. 2, the document analyzing unit 101 includes a processing engine 103 or plurality of processing modules configured to perform combinatorial document matching. In one embodiment, processing engine 103 represents a central processing unit (CPU), microcontroller, microprocessor, or logic configured to execute programming instructions associated with the combinatorial document matching system 100. Computer-readable storage medium 111 represents volatile storage (e.g. random access memory), non-volatile store (e.g. hard disk drive, read-only memory, compact disc read only memory, flash storage, etc.), or combinations thereof. Furthermore, storage medium 111 includes software 113 that is executable by processing engine 103 and, that when executed, causes the processing engine 103 to perform some or all of the functionality described herein. For example, elements or processing modules of the document matching unit 101 may be implemented as executable software within storage medium 111. Additionally, the document analyzing unit 101 is configured to communicate with an internetwork 106 for gather further search and analytical information. Based on the analysis of the target document, set of source documents, and internetwork information, the document analyzing unit 101 is configured to produce a set of relevant and matching documents 155 for the target document.

FIG. 2 is a more detailed block diagram of the combinatorial document matching system according to an example of the present invention. As shown here, combinatorial document matching system 200 includes a target document 202 and set of source documents 204. In the present example, the document analyzing unit 201 includes text analyzer 205, concepts parser 230, and concept comparator 240, which may be individual processing modules or elements of the processing engine 203. A set of source documents 204 are identified and input into the text analyzer 205. The text analyzer 205 is configured to identify, tag, and extract the key concepts and phrases from each of the source documents 204. According to one example embodiment, the text analyzer 205 includes a word stemmer 207, stop word eliminator 208, and an occurrence matrix 209 for facilitating text analysis. More specifically, given an input document, the stop word eliminator 208 analyzes the text of the document and determines whether a particular word is a stop-word, which are frequently used words in the English language such as if, and, when, how, I, we, etc. Additionally, given two or more input words, the word stemmer 207 decides if the words arise from the same root/stem so that they may be group together in the analysis process. For instance, the following word pairs have a common root: relational and relate, book and books, requested and request, digitization and digital, defend and defensible, etc. Still further, the text analyzer 205 may also include an occurrence matrix 209 for identifying the co-occurrence or semantic relationships of key phrases through construction and clustering of select words. According to one example, if two terms occur frequently next to each other, then their co-occurrence count is determined to be high and thus may be identified as a key phrase. Moreover, in order to improve the context-awareness of document analysis, external information sources 206 may be leveraged so as to augment the text analysis of the source document set 204. As a result, a data set 215 of taxonomies, concepts, and relations (i.e., relevant and associative source information), including pointers or vectors to their related source documents are extracted for each source document via the text analyzer 205. The data set 215 output from the text analyzer 205 may then be consolidated with the source document set 205 to create consolidated source document information 220, which may be physical or virtual.

Similarly to the process of analyzing the related document set 204 described above, the text analyzer 205 is also utilized for analyzing the target document 202, which may be declared and input into the combinatorial document matching system 200 by an operating user for example. That is, concept and phrase extraction of the target document 202 is facilitated using elements 207, 208, and 209 of the text analyzer 205 so as to create vectors, or pointers to a dynamically allocated data array, of key concepts 225 associated with the target document 202. Thereafter, concept parser 230 is configured to analyze and parse the concepts 225 into all possible permutations. For example, concepts ABXY associated with the target document may be parsed into A+BXY, AB+XY, ABX+Y, B+AXY, BX+AY etc. The possible permutations are then used to form the permutated concept data set 235, which may be a set of vectors associated with various concept combinations of the target document 202. In the present example, combinatorial document matching is performed by the concept comparator 240 analyzing and comparing data of the consolidated source document information 220 with data (e.g., permutated concept data set 235) affiliated with the target document 202. More generally, the concept comparator 240 matches concepts of the target data with the concepts of at least a pair of documents associated with the consolidated relevant document source 220. According to one example embodiment, the concept comparator 240 utilizes the document pointers (i.e., vectors associated with information 220 and 235) for compiling a set of relevant documents/concepts 245, which in combination, match or substantially correspond to the concepts disclosed in the target document 202.

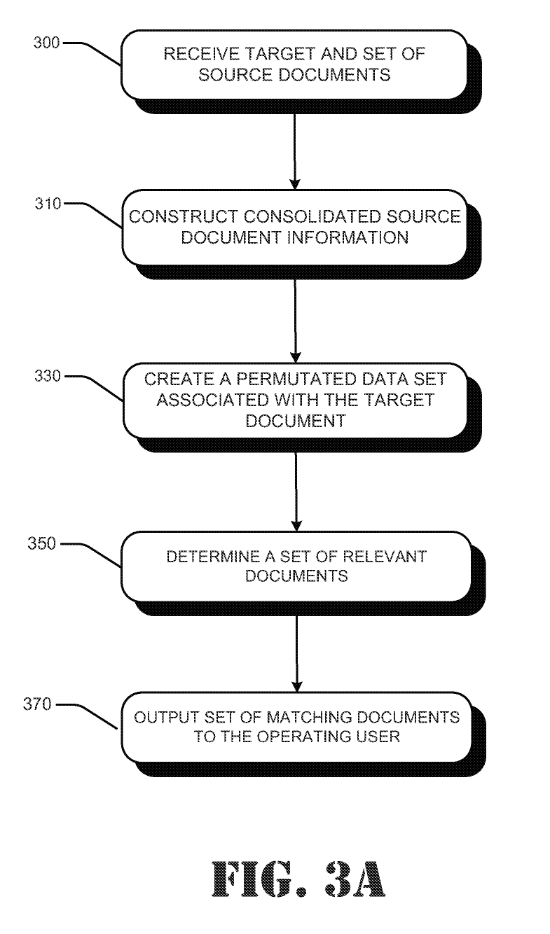

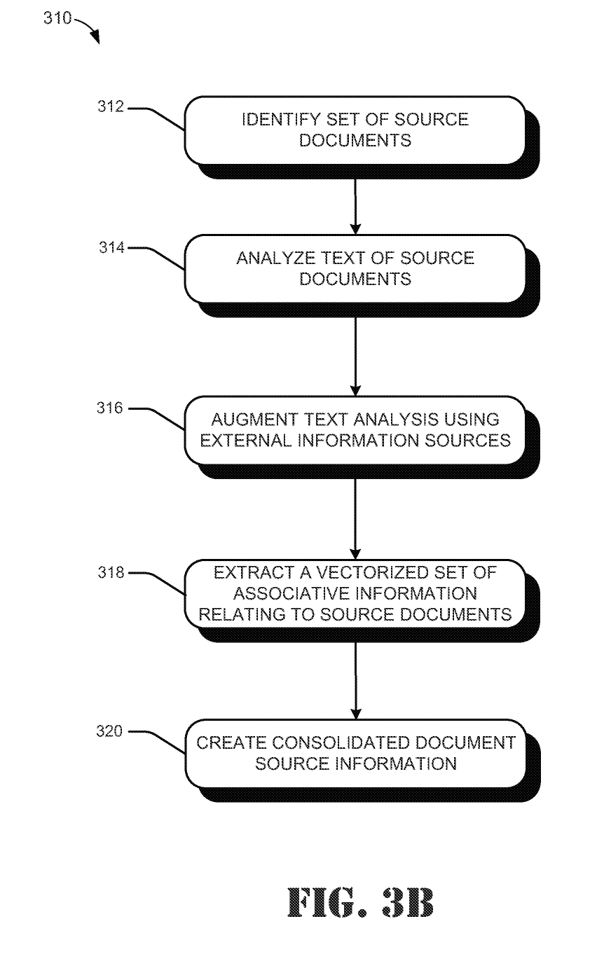

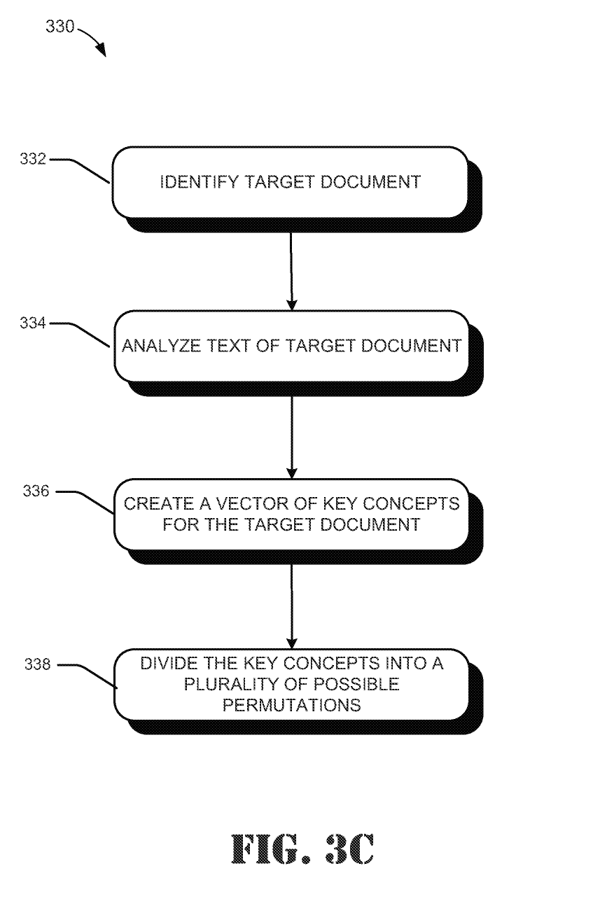

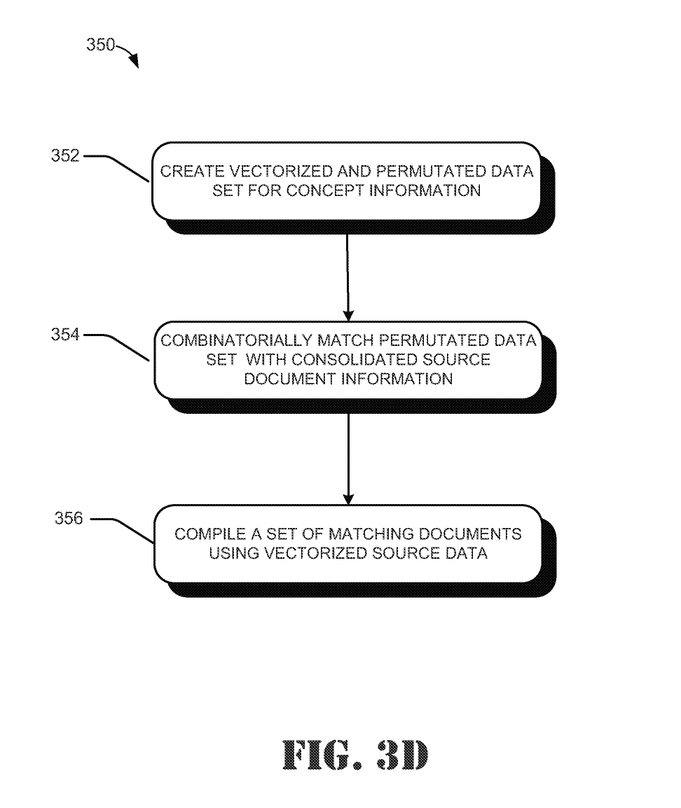

FIG. 3A is a simplified flow chart of the processing steps of a method for performing combinatorial document matching in accordance with an example of the present invention. Initially, in step 300, a target document and a set of source documents are received by the document analyzing unit. The document matching system then creates consolidated source document information that will be used for comparison with aspects of the target document. Additionally, a permutated data set associated with the target document is generated in step 330. In step 350, a set of matching documents are determined by the system and then output to the operating user for review (e.g., via a display screen) in step 370.

FIG. 3B is a simplified flow chart of the processing steps for constructing consolidated source document information (310) in accordance with an example of the present invention. As shown here, in step 312 the system initially identifies a set of source documents. Next, in step 314, the document analyzing unit and/or text analyzer identifies, tags, and extracts the key concepts from each of the source documents within the set. For example, given an input document, each word in the document is passed through the stop-word eliminator and if the word is not a stop-word then it is retained for further analysis. Then, each pair of words is passed through a word stemmer and words having the same root/stem are grouped together. The co-occurrence matrix may then be used for identifying the key phrases in the documents based on the semantic similarity and co-occurrence rate of certain phrases within the document. In step 316, external information sources may be used to augment the text analysis of source document. For example, an online keyword extraction tool provided by search engines (i.e., external information source) may be used for keyword extraction. Such tools may accept a paragraph (e.g., patent claim) as input and output a set of keywords and key phrases. Based on the text analysis, in step 318 a vectorized set of associative information—data pertaining and linked to individual source documents—including taxonomies, concepts, and relations, is extracted by the combinatorial document matching system. Thereafter, in step 320, consolidated document source information is created through on the extracted relevant and associative source information and the set of source documents.

FIG. 3C is a simplified flow chart of the processing steps for creating a permutated data set associated with the target document (330) according to an example of the present invention. In step 332, a target document is input by the operating user and identified by the combinatorial document matching system. Next, in step 334, the system, via the text analyzing module for example, examines the text of the document in order to extract and create concept information associated with the target document in step 336. As described above, the concept information comprises of a plurality of vectors associated with and highlight identified key phrases/words of the target document based on the text analysis. Additionally, in step 338 the combinatorial document matching system parses the identified concepts and phrases into all possible permutations, (e.g., concepts ABC may be parsed to A+BC, AB+C, B+AC, etc.).

FIG. 3D is a simplified flow chart of the processing steps for determining a set of relevant documents (350) in accordance with an example of the present invention. In step 352, a permutated data set affiliated with the target document is created and vectorized based on the possible combinations of the key phrases of said document. For instance, the combinatorial document matching system may create sets of concept vectors pointing to various subsections or elements of the target source. In step 354, the consolidated source document information is combinatorially matched against the permutated concept data set. More particularly, and in accordance with one example embodiment, vectors of the consolidated source document information are juxtaposed with the vectors of the permutated data set such that relevant documents (at least two), or those source documents matching at least one complete permutation or instantiation (i.e., ABXY), are flagged by the system. In step 356, based on the combination of source documents via document pointers (e.g., source document 1 has AB and source document 2 has XY), a set of relevant and matching documents with respect to the target document is compiled by the system.

In the context of claim obviousness detection—when given a target document having a least one claim and at least two source documents as input—the combinatorial document matching system of the present examples may denote concept information or keywords of the target document as “P”, and keywords of the source document denoted by “S”. In the present example, S may consist of N subsets of keywords for each of its N claim elements, while P consists of M subsets of keywords for each of its M elements. In combinatorial concept vector and comparator, given a set S of keywords and key phrases (i.e., concept information) associated with the source documents, and P of keywords/phrases affiliated with the target document/claim, the concept comparator may estimate the similarity between S and P. In a given repository of documents, the existence of many documents that contain both the source keywords S and the target keywords P may serve to indicate that the sets S and P are likely to be relevant. Still further, external information sources (i.e., internetwork) may be used as the document repository, and, in such a scenario, results of a general-purpose search engine may be used as a proxy to estimate the number of documents common to both target document keywords, P, and the source keywords, S.

Furthermore, the variable “A” may denote any subset of P, while “B” denotes any subset of S. Here, |A| may represent the number of documents that contain A; |B| representing the number of documents containing B; while |A, B| represents the number of documents that contain both A and B. The similarity between A and B may then be computed as min (|A|,|B|)/|A, B|. Given any A, the subset B of S that maximizes the similarity ratio may be taken as A's counterpart in S (i.e., substantially similar). Moreover, given P and S, their similarity is taken as the sum of the similarity ratios of the counterpart subsets (A's and B's) of P and S. With respect to the text analysis, stop-words are eliminated from sets A and B. If a word in A and a word in B have the same stem, then they may be considered to be the same word. High occurring or key phrases in A and B are constructed by the co-occurrence matrix as described above. Moreover, when a search engine is used as a proxy for determining the number of documents common to P and S, the repository becomes the internetwork. In this example, |A| may represent the number of documents that a general-purpose search engine retrieves in response to A, with |B| representing the number of documents that the search engine retrieves in response to B, and |A, B| the number of documents that the search engine retrieves in response to A and B.

Examples of the present invention provide a system and method for combinatorial matching for a plurality of documents. Moreover, the physical manifestation of disclosed method may be observed in the compilations of books, journals, reports, and other document sources that may be required for a business purpose. Furthermore, many advantages and utilities are afforded by examples of the present invention. For example, in an RFP/RFI response in sales, a request for proposal (RFP) or request for information (RFI) may be used as target documents and a combination of sales collaterals can be identified as source documents. The present method may be used to quickly extract the key requirements from the RFP/RFI and search for a combination of assets that collectively meet the stated requirements. Such an implementation of the examples described herein will benefit from specialized taxonomies, legal clauses, pricing models, and other features unique to the sales process.

As described above, patent obviousness detection in which claims of a patent application are used to identify prior art references under 35 U.S.C. Section 103, is aided by the invention described herein and is applicable to initial patent search, patent examination, and patent litigation. Given knowledge of patent claims, claims are parsed to extract inventive elements and their relationships. As patent filings and litigations increase, there is an increasing demand for more effective detection of patent obviousness. Ample patent data is readily available, but detection of patent obviousness is generally a hard problem since it involves finding a combination of relevant patents that combined together subsume the claims of a new patent application. Implementation of the present teachings have yielded positive results when applied to semantic analysis of the first independent claim of patents and thus provides a realistic means for drastically reducing the time and resources for patent prosecution, examination, and the discovery phase in patent litigation.

Advantages further include the extension of conventional eDiscovery capabilities to locating documents that partially address the legal question. Moreover, legal precedent, where the facts of a case are used to identify legal sources (e.g., statutes, case law, etc.) as precedent, may be enhanced and simplified through the combinatorial document matching system of the present examples. Still further, the detection of plagiarism can be improved such that sections of a set of source documents are analyzed to test the originality of a target document.

Furthermore, while the invention has been described with respect to exemplary embodiments, one skilled in the art will recognize that numerous modifications are possible. Thus, although the invention has been described with respect to exemplary embodiments, it will be appreciated that the invention is intended to cover all modifications and equivalents within the scope of the following claims.

What is claimed is:

1. A computer-implemented method for combinatorial document matching comprising:
receiving, at a system having a processor, a target document and a plurality of source documents;
constructing, via the system, consolidated source document information associated with the plurality of source documents;
creating, via the system, permutated concept data affiliated with the target document; and
determining, via the system, a set of relevant documents from the plurality of source documents based on a comparison of the permutated concept data and the consolidated source document information.

2. The method of claim 1, further comprising:
outputting, via the system, the set of matching documents for review by an operating user.

3. The method of claim 1, wherein the step of constructing consolidated source document information further comprises:
analyzing, via the system, text of each of the plurality of source documents so as to extract associative source information therefrom,
wherein the associative source information includes taxonomies, concepts, and relations relating to each source document.

4. The method of claim 3, wherein the step of creating permutated concept data further comprises:
analyzing, via the system, text of each of the plurality of source documents so as to extract concept information therefrom; and
separating, via the system, the concept information into a plurality of possible permutations,
wherein the concept information includes a plurality of keywords and key phrases associated with at least one defined section of a target document.

5. The method of claim 4, wherein the step of determining a set of relevant documents further comprises:
combinatorially matching the associative source information relating to the plurality of source documents against the permutated concept data associated with the target document;
compiling a set of matching documents based on the substantially similarity between at least one instantiation within the permutated concept data set and a combination of at least two source documents.

6. The method of claim 1, further comprising:
analyzing semantic relationships of the text information for the plurality of source documents and/or target document via an external information source.

7. A non-transitory computer readable storage medium having stored executable instructions, that when executed by a processor, causes a combinatorial document matching system to:
construct, based on a received set of source documents, consolidated source document information associated with the plurality of source documents;
create, based on a received target document, permutated concept data affiliated with the target document; and
determine a set of relevant documents from the plurality of source documents through comparison of the permutated concept data and the consolidated source document information.

8. The computer readable storage medium of claim 7, wherein the computer-executable instructions further cause the system to:
output the set of matching documents for review by an operating user.

9. The computer readable storage medium of claim 7, wherein the step of constructing consolidated source document information includes executable instructions that further cause the processor:
analyze text of each of the plurality of source documents so as to extract associative source information therefrom,
wherein the associative source information includes taxonomies, concepts, and relations relating to each source document.

10. The computer readable storage medium of claim 9, wherein the step of creating permutated concept data includes executable instructions that further cause the processor to:
analyze text of each of the plurality of source documents so as to extract concept information therefrom; and
divide the concept information into a plurality of possible permutations,
wherein the concept information includes a plurality of keywords and key phrases associated with at least one defined section of a target document.

11. The computer readable storage medium of claim 10, wherein the step of determining a set of matching document includes executable instructions that further cause the processor to:
combinatorially match the associative source information relating to the plurality of source documents against the permutated concept data associated with the target document; and
compile a set of relevant documents based on the substantially similarity between at least one instantiation within the permutated concept data set and a combination of at least two source documents.

12. The computer readable storage medium of claim 7 including executable instructions that further cause the processor to:
analyze semantic relationships of the text information for the plurality of source documents and/or target document via an external information source.

13. A combinatorial document matching system comprising:
a processing engine configured to execute programming instructions and including:
a text analyzing module configured to extract concept information from an identified target document and a plurality of source documents,
a concept parsing module configured divide concept information associated with the target document into a permutation data set;
a combinatorial concept comparator configured to compare the permutated concept data of the target document with consolidated source document information generated from the plurality of source documents.

14. The system of claim 13, wherein text of each of the plurality of source documents and the target document are analyzed so as to extract concept information therefrom,
wherein the concept information includes a plurality of keywords and key phrases associated with each source document and the target document.

15. The system of 13, wherein concept information associated with the plurality of source documents is combinatorially matched against the permutated concept data associated with the target document, and
wherein a set of matching documents are compiled based on a substantially similarity between at least one instantiation within the permutated concept data set and a combination of at least two source documents.
